(19) United States
(12) Patent Application Publication
(10) Pub. No.: US 2019/0009213 A1
(43) Pub. Date: Jan. 10, 2019

(54) EXHAUST GAS TREATMENT SYSTEM

(71) Applicant: Scania CV AB, Södertälje (SE)

(72) Inventor: David RAYMAND, Uppsala (SE)

(73) Assignee: Scania CV AB, Södertälje (SE)

(21) Appl. No.: 16/067,077

(22) PCT Filed: Dec. 13, 2016
(86) PCT No.: PCT/SE2016/051250

§ 371 Date: Jun. 28, 2018

(30) Foreign Application Priority Data
Jan. 27, 2016 (SE) 1650091-0

(51) Int. Cl. B01D 53/94; B01J 23/22; B01J 23/40; B01J 35/04; B01J 35/00; B01J 23/92; B01J 23/96; B01J 38/02; B01D 53/96; F01N 3/035; F01N 3/025; F01N 3/20

(52) U.S. Cl. CPC B01D 53/9477; F01N 2570/12; B01J 23/40; B01J 35/04; B01J 35/0006; B01J 23/92; B01J 23/96; B01J 38/02; B01D 53/944; B01D 53/9418; B01D 53/96; F01N 3/035; F01N 3/0253; F01N 3/2066; B01D 2251/2067; B01D 2255/1021; B01D 2255/20723; B01D 2255/9032; B01D 2257/404; B01D 2257/702; F01N 2250/02; F01N 2560/06; F01N 2570/14; B01J 23/22

(57) ABSTRACT

Provided are an exhaust gas treatment system and method for regenerating the exhaust gas treatment system. The exhaust gas treatment system comprises: an oxidation catalyst assembly; a particulate filter downstream of the oxidation catalyst assembly; a reducing agent dosing device downstream of the particulate filter; and a selective catalytic reduction device downstream of the reducing agent dosing device. The oxidation catalyst assembly comprises a first oxidation catalyst to selectively oxidize hydrocarbons in the exhaust stream, at least partially, with substantially no concomitant oxidation of sulfur oxides in the exhaust stream; and a second oxidation catalyst downstream of the first oxidation catalyst, to oxidize hydrocarbons or partially oxidized hydrocarbons having slipped through the first oxidation catalyst, as well as to concomitantly oxidize NO to NO₂. The system can be regenerated when running on high-sulfur fuels to regenerate the particulate filter as well as remove sulfur species deposited on the system catalysts.

### CROSS-REFERENCE TO RELATED APPLICATION(S)

This application is a National Stage Application (filed under 35 § U.S.C. 371) of PCT/SE2016/051250, filed Dec. 13, 2016 of the same title, which, in turn claims priority to Swedish Application No. 1650091-0 filed Jan. 27, 2016 of the same title; the contents of each of which are hereby incorporated by reference.

### FIELD OF THE INVENTION

The present disclosure relates in general to an exhaust gas treatment system comprising an oxidation catalyst assembly, a particulate filter, a reducing agent dosing device and a selective catalytic reduction device. The exhaust gas treatment system may for example be an exhaust gas treatment for a vehicle, especially a heavy vehicle such as a bus or a truck. The present disclosure also relates to a method for regenerating the particulate filter of the exhaust gas treatment system.

### BACKGROUND OF THE INVENTION

An internal combustion engine combusts a fuel and air mixture in order to generate a driving moment for powering for example a heavy vehicle, such as a bus or truck. The combustion process generates exhaust gases which exit the engine and are transferred to an exhaust gas treatment system. For a diesel engine, the exhaust gases from the internal combustion engine mainly comprise nitrogen containing gases (NOₓ), carbon dioxide (CO₂), carbon monoxide (CO), hydrocarbon (HC), and particulates. NOₓ is a commonly used generic term to describe the nitrogen containing gases, which primarily comprises nitrogen monoxide (NO) and nitrogen dioxide (NO₂).

The exhaust gas treatment system often comprises a diesel oxygen catalyst (DOC) adapted to primarily oxidize hydrocarbons, but also carbon monoxide and nitrogen monoxide. Furthermore, the exhaust gas treatment system often comprises a selective catalytic reduction (SCR) catalyst in which a reducing agent and NOₓ are converted into nitrogen and water, thereby reducing the amount of NOₓ released to the surrounding atmosphere. The reducing agent used is usually a urea-containing aqueous solution, also known as diesel exhaust fluid, standard AUS 32 of ISO 22241 or by the tradename Adblue. The reducing agent is introduced into the system upstream of the SCR.

The exhaust gas treatment system typically further includes one or more particulate filters, for example a diesel particulate filter (DPF) such as a catalysed soot filter (CSF), in order to trap particulates in the exhaust gas. Additional types of catalysts may also be provided in the exhaust gas treatment system, for example an ammonium slip catalyst (ASC) in order to avoid ammonia tailpipe emissions.

The diesel particulate filter accumulates particulate matter during operation and therefore must be regenerated regularly to remove any combustible particulate matter, essentially soot. In markets where fuel quality is highly regulated, the particulate filter can be provided with a coating of an oxidation catalyst (catalysed DPF, cDPF) and/or have a DOC arranged upstream. These catalysts oxidize NO to NO₂, which is a highly effective oxidant for soot. The presence of these catalysts therefore enable the oxidation of soot at relatively low temperatures, allowing continuous regeneration of the filter under normal operating conditions. This is known as passive regeneration. If passive regeneration is insufficient to provide for complete removal of combustible particulates, the temperature of the exhaust gases flowing through the particulate filter can be temporarily raised in order to fully remove combustible material. This is known as active regeneration and can be achieved either by regulating the engine to provide higher exhaust temperatures, or by providing fuel to the diesel oxidation catalyst, which in an exothermic reaction oxidizes the fuel, thus raising the exhaust temperature downstream of the oxidation catalyst.

A number of problems arise however when low quality fuels are used in advanced exhaust treatment systems. Low quality fuels typically contain significant amounts of sulfur. The sulfur in these fuels can in the worst case poison any oxidation catalysts present in the exhaust system, such as the diesel oxidation catalyst or the catalytic coating of the particulate filter, leading to a permanent and irreversible deactivation of these catalysts. Fortunately, catalyst development has led to the availability of catalysts that are resilient to permanent poisoning.

However, the presence of sulfur in fuel is still problematic. The sulfur is oxidized in the combustion process to sulfur dioxide (SO₂). Oxidation catalysts can catalyse the further oxidation of sulfur dioxide to sulfur trioxide (SO₃), which in turn can react further to provide sulfuric acid, ammonium bisulfate and other sulfur species. These oxidized sulfur species can bind weakly to the catalyst metals, be absorbed by catalyst washcoats and/or deposit on catalytic surfaces, all of which lead to a loss of catalytic activity. If the diesel oxidation catalyst and diesel particulate filter are deprived of catalytic activity, insufficient NO₂ is formed to oxidize soot, and the particulate filter cannot be passively regenerated.

Fortunately, the bound or deposited sulfur species can be removed by heating, and the catalytic activity of the oxidation catalysts (DOC and/or cDPF) can therefore be regained. This is done by raising the temperature of the catalysts in excess of the boiling point of sulfuric acid (337° C.). However, since the diesel oxidation catalyst has been deactivated by sulfur, it cannot readily be used to raise the temperature of the exhaust gas by exothermic oxidation of fuel. Thus, the only feasible method of achieving such temperature increases is by regulating the engine to produce elevated exhaust temperatures, leading to increased fuel usage and wear of engine components.

US2010/0229539 A1 discloses an exhaust aftertreatment system comprising an SCR device, wherein no significant amount of catalysed material is present in the exhaust stream upstream of the SCR device. Avoiding a significant amount of catalyzed material or bodies upstream of the SCR prevents sulfate poisoning that would deactivate the SCR. However, because the disclosed aftertreatment system avoids catalyzed bodies upstream of the SCR, an additional heat source is needed to regenerate the bare DPF. This heat source can for example be a fuel fired burner.

US2003/0115859 A1 discloses a diesel engine exhaust system comprising a soot filter and a low temperature NO₂ trap material deposited on a carrier upstream and in train with the soot filter. In certain embodiments, a layer containing a catalyst effective for the oxidation of soot, for example V₂O₅, can be deposited on the upstream side of the walls of the soot filter. The downstream side of the soot filter can be coated with a catalyst washcoat composition preferably containing platinum group metals. However, the application is silent with regards to the problems associated with the use of high-sulfur fuels, or how to regenerate sulfur-poisoned exhaust gas treatment systems.

Thus, there remains a need for an exhaust treatment system that allows for a reliable, effective and fuel-efficient regeneration of the system components, and in particular the particulate filter, even if using high-sulfur fuels.

### SUMMARY OF THE INVENTION

The inventor of the present invention has recognized that regenerating prior art exhaust gas treatment systems after catalyst poisoning by using high-sulfur fuels requires increasing the temperature of the engine exhaust stream through regulation of the engine. The inventor of the present invention has recognized that such a regeneration procedure is inefficient with regard to fuel consumption and increases component wear in the engine, thus shortening component lifetimes.

Therefore, it is an object of the present invention to provide a system for the treatment of exhaust gas and a method for the regeneration of such a system that enables optimal exhaust gas treatment if using low-sulfur fuels whilst still providing satisfactory exhaust gas treatment if using high-sulfur fuels.

It is also an object of the present invention to provide a system and method that allows for a robust and fuel-efficient regeneration of the particulate filter even if the system is poisoned by using high-sulfur fuels.

It is a further object to provide a system and method that allows the full and complete recovery of system catalysts after poisoning with high-sulfur fuels, in a robust and fuel efficient manner.

The above-mentioned objects are achieved by an exhaust gas treatment system according to the appended claims.

The exhaust gas treatment system is arranged for treatment of an exhaust stream that results from a combustion in a combustion engine, and comprises:

an oxidation catalyst assembly;

a particulate filter arranged downstream of the oxidation catalyst assembly;

a reducing agent dosing device arranged downstream of the particulate filter, and arranged to supply a reducing agent into the exhaust stream; and

a selective catalytic reduction device arranged downstream of the reducing agent dosing device, and arranged to reduce nitrogen oxides in the exhaust stream using the reducing agent supplied upstream.

The oxidation catalyst assembly comprises:

a first oxidation catalyst arranged to selectively oxidize hydrocarbons present in the exhaust stream, at least partially, with substantially no concomitant oxidation of sulfur oxides present in the exhaust stream; and

a second oxidation catalyst arranged downstream of the first oxidation catalyst, arranged to oxidize hydrocarbons or partially oxidized hydrocarbons having slipped through the first oxidation catalyst, as well as to concomitantly oxidize NO to NO₂.

The inventor of the present invention has realized that an exhaust gas treatment system comprising an oxidation catalyst assembly as defined above achieves the objects of the invention as previously described. When using low-sulfur fuel, the above system provides excellent emissions treatment, fully comparable to prior art systems. When using high-sulfur fuels the above system still provides satisfactory emissions performance. The above-defined system can regenerate the particulate filter by dosing fuel to the exhaust stream being treated, even when using high-sulfur fuels, which is a fuel-efficient and robust method of regeneration. Moreover, the system can fully recover catalyst activity upon regeneration with low-sulfur fuels, which again is fuel-efficient and robust. Moreover, the above advantages can, at least for some embodiments, be achieved without an increase in production cost despite the fact that the oxidation catalyst assembly comprises two different oxidation catalysts since the volume of the second oxidation catalyst (which often comprises platinum group metals) can be reduced compared to prior art systems. Furthermore, the system is mostly composed of components similar in function and dimension to prior art components. Because the oxidation catalyst assembly need be no larger than prior art diesel oxidation catalysts, the system can be provided to vehicles designed for prior art systems with a minimum of reengineering required. Also, the system can be regenerated using the same control logic as prior art systems meaning that little software reengineering is required.

According to one feature, the first oxidation catalyst may comprise vanadium pentoxide. This provides a cost-effective, robust and long-lived catalyst. The vanadium loading of the first oxidation catalyst may be 1-2.5 weight %, or preferably 1-1.5 weight %. This ensures that a sufficient amount of catalytic material is present for the optimal functioning of the first oxidation catalyst.

According to another feature, the second oxidation catalyst may comprise a platinum group metal (PGM), preferably platinum. PGM catalysts are well-established for use as oxidation catalysts in automotive applications. The platinum group metal loading of the second oxidation catalyst may be 1-50 g/ft³. This ensures that a sufficient amount of catalytic material is present for the optimal functioning of the second oxidation catalyst.

According to yet another feature, the particulate filter may be catalysed. This can be achieved by utilizing a particulate filter comprising a platinum group metal, preferably platinum. The use of a catalysed particulate filter allows for passive regeneration of the particulate filter at lower operational temperatures as compared to a non-catalysed particulate filter.

According to still another feature, the first and second oxidation catalysts may be of the non-plugged flow-through monolith type. This provides catalysts with an optimal combination of high catalytic surface area and good flow (i.e. little pressure drop) across the catalysts.

The first oxidation catalyst may be deposited on a first catalyst support and the second oxidation catalyst may be deposited on a second catalyst support. This allows for a simple manufacturing process for the supported catalysts and minimizes the risk of poisoning the PGM catalyst with vanadium pentoxide. Alternatively, the first oxidation catalyst may be deposited on a first portion of a shared catalyst support and the second oxidation catalyst may be deposited on a second portion of the shared catalyst support, wherein the first portion of the catalyst support is arranged upstream of the second portion of the catalyst support. An oxidation catalyst assembly manufactured in this fashion may be used as a “drop in” replacement for prior art diesel oxidation catalysts. The volume ratio of the first oxidation catalyst to the second oxidation catalyst may be 4:1 to 1:4, preferably 1.5:1 to 1:1.5.

According to another aspect of the present invention, the above-mentioned objects are achieved by a method of regenerating the exhaust gas treatment system disclosed above. The method comprises the steps of dosing fuel to an exhaust stream upstream of an oxidation catalyst assembly and regulating the fuel dosing using feedback control in order to reach a target regeneration temperature of the exhaust gas stream, as measured by a temperature sensor arranged downstream of the oxidation catalyst assembly and upstream of a particulate filter. The temperature sensor may be a physical temperature sensor, or it may be a virtual temperature sensor.

According to one feature of the above method, the fuel may be dosed to the exhaust stream by regulating a combustion engine to release uncombusted fuel into the exhaust stream. This allows for the dosing of fuel to the exhaust stream without the need for additional dosing apparatus. According to another feature of the above method, the fuel may be dosed to the exhaust stream using a fuel dosing device arranged upstream of the oxidation catalyst assembly. This is a reliable method of providing fuel to the exhaust stream independently of the combustion engine. Naturally, both of these methods of dosing fuel to the exhaust stream may be used in combination if desired.

The present invention further relates to a motor vehicle comprising the exhaust gas treatment system as disclosed above.

Further aspects, objects and advantages are defined in the detailed description below with reference to the appended drawings.

### BRIEF DESCRIPTION OF THE DRAWINGS

For the understanding of the present invention and further objects and advantages of it, the detailed description set out below can be read together with the accompanying drawings, in which the same reference notations denote similar items in the various diagrams, and in which:

FIG. 1 schematically illustrates a side view of a vehicle comprising an internal combustion engine and an exhaust gas treatment system.

FIG. 2 schematically illustrates an exhaust gas treatment system in accordance with an exemplifying embodiment of the present invention.

FIG. 3 schematically illustrates a test setup for testing the function of a system according to the present invention.

FIG. 4 shows exhaust gas temperatures, NOₓ ratios and hydrocarbon concentrations as a function of time during regeneration testing.

FIG. 5 shows temperatures at the first oxidation catalyst inlet, intermediate the first and second oxidation catalyst, at the second oxidation catalyst outlet, and at the particulate filter outlet during regeneration testing.

### DETAILED DESCRIPTION OF THE INVENTION

Henceforth, the terms “downstream” and “upstream” are used with reference to the general direction of exhaust flow, from the exhaust gas treatment inlet, via the oxidation catalyst assembly, particulate filter and SCR device, to the exhaust gas treatment outlet.

Henceforth, by low sulfur fuel, it is meant fuels having a sulfur content of 15 ppm or lower. By high sulfur fuel it is meant fuels having a sulfur content of greater than 100 ppm.

According to the present system for exhaust gas treatment, and method for regenerating a system for exhaust gas treatment, it is possible to actively regenerate a soot-filled particulate filter even if the system platinum-group metal (PGM) catalysts have been poisoned due to the use of high-sulfur fuels. This regeneration can be performed without resorting to using increased engine load in order to raise the temperature of the exhaust stream exiting the combustion engine of the vehicle. Thus fuel economy is improved and vehicle component wear is avoided. Moreover, when using high-quality, low-sulfur fuels, the system performs in an analogous manner to prior art exhaust gas treatment systems, despite potentially requiring lesser amounts of precious platinum-group metals (PGM). The exhaust gas treatment system is especially suitable for use in motor vehicles, particularly heavy vehicles such as trucks or buses.

The exhaust gas treatment system of the invention comprises an oxidation catalyst assembly comprising a first oxidation catalyst and a second oxidation catalyst. The first oxidation catalyst is substantially inert to sulfur and sulfur poisoning, but is capable of at least partially oxidizing hydrocarbons at typical operating temperatures. Thus, the first oxidation catalyst can selectively oxidize hydrocarbons present in the exhaust stream, at least partially, with substantially no concomitant oxidation of sulfur oxides present in the exhaust stream. By “substantially no concomitant oxidation of sulfur oxides” it is meant that at the operating conditions and exhaust gas compositions typical for the invention, the first oxidation catalyst produces insignificant amounts of sulfur trioxide, i.e. amounts of SO₃ insufficient to lead to any significant loss of activity in the first oxidation catalyst.

The second oxidation catalyst is preferably a typical diesel oxidation catalyst (DOC) that is capable of completely oxidizing hydrocarbons to CO₂. However, such catalysts are typically prone to reversible deactivation by sulfur. The system further comprises a particulate filter (which optionally may be catalysed) downstream of the oxidation catalyst assembly, a reducing agent dosing device downstream of the particulate filter, and a selective catalytic reduction (SCR) device downstream of the reducing agent dosing device.

If the vehicle is running on regular low-sulfur fuel, the exhaust gas treatment system provides comparable results to prior art exhaust gas treatment systems. The first oxidation catalyst of the present system partially oxidizes hydrocarbons present in the exhaust stream, and the second oxidation catalyst completes the oxidation of hydrocarbons in the exhaust stream, thus avoiding hydrocarbon slip and carbon monoxide downstream, as well as oxidizing NO to NO₂. This NO₂ acts as an oxidant for soot collected in the particulate filter, meaning that the soot can be continuously removed in a passive regeneration process under typical operating conditions. If excessive soot is collected in the particulate filter, the rate of soot removal may be increased by providing fuel to be oxidized to the oxidation catalyst assembly, thus raising the temperature downstream of the oxidation catalyst assembly. This is a fuel-efficient means of actively regenerating the particulate filter, and avoids wear of engine components.

If the vehicle is running on high-sulfur fuel, the second oxidation catalyst and catalysed particulate filter, if present, are rapidly, but reversibly, deactivated by the sulfur oxides in the exhaust stream. Thus, the system cannot catalytically oxidize NO in the exhaust stream to NO₂ and the particulate filter cannot be passively regenerated. Importantly however, the first oxidation catalyst is not susceptible to sulfur poisoning since it has a low activity towards sulfur oxides, and therefore it retains its hydrocarbon oxidizing activity. Also, particulates are still collected in the particulate filter, the SCR device still reduces NOₓ in the exhaust stream to N₂ and the emissions performance of the exhaust gas treatment system is therefore still satisfactory, although not necessarily at the same level as with low-sulfur fuels.

Since the particulate filter is not being passively regenerated if the vehicle is run on high-sulfur fuels, soot will accumulate in the particulate filter and it will need to be actively regenerated sooner or later in order to avoid excessive back-pressure in the exhaust system, as well as the risk of thermal runaway in the particulate filter.

A prior art exhaust gas treatment system, lacking a selective first oxidation catalyst, is largely incapable of increasing the exhaust stream temperature by using catalytic oxidation when using high-sulfur fuels because the oxidation catalysts in the system are deactivated. Thus, the only readily available alternative for prior art systems is increasing the load on the combustion engine in order to provide exhaust stream temperatures sufficient to reactivate the system catalysts and regenerate the particulate filter. This requires excessive fuel consumption and leads to excessive wear of engine components. Other feasible methods of active regeneration may be the use of catalytic fuel additives, or the inclusion of a fuel burner device in the exhaust treatment system, but these methods too are undesirable.

The exhaust gas treatment system of the present invention can however be readily regenerated, and the PGM catalysts (DOC and cDPF) reactivated, by providing unburned fuel to the exhaust stream. This can be done by controlling injection to the combustion engine, or by a separate fuel dosing device arranged in the exhaust gas treatment system upstream of the oxidation catalyst assembly. Because the first oxidation catalyst is substantially insusceptible to deactivation by sulfur, it readily oxidizes (at least partially) the fuel added to the exhaust stream, generating heat. The heat generated is sufficient to desorb and/or evaporate sulfur species deposited on the catalysts downstream. When the second oxidation catalyst regains activity, the NO oxidizing ability of the system is also regained and the NO₂ generated by the second oxidation catalyst (and catalysed particulate filter if present), together with the elevated temperatures of the exhaust stream, lead to an efficient soot removal from the particulate filter.

Naturally, the exhaust gas treatment system can also be used with vehicles running on fuels having sulfur contents intermediate those of low-sulfur fuel and high-sulfur fuel as defined above.

The invention will now be described in more detail with reference to certain exemplifying embodiments and the drawings. However, the invention is not limited to the exemplifying embodiments discussed herein and/or shown in the drawings, but may be varied within the scope of the appended claims. Furthermore, the drawings shall not be considered drawn to scale as some features may be exaggerated in order to more clearly illustrate certain features.

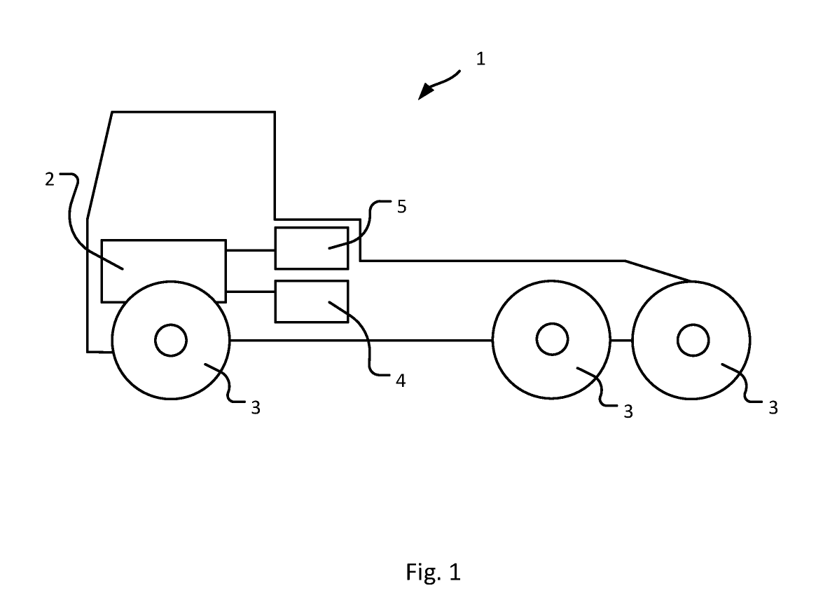

FIG. 1 depicts a vehicle 1, here in the form of a truck, in a schematic side view. The vehicle may however be any other motor driven vehicle, for example a bus, a watercraft, or a passenger car. The vehicle comprises a combustion engine 2 which powers the vehicle's tractive wheels 3 via a gearbox (not shown) and a propeller shaft (not shown). The engine is provided with an exhaust gas treatment system 4. The engine is powered by fuel supplied to it via a fuel system which comprises a fuel tank 5.

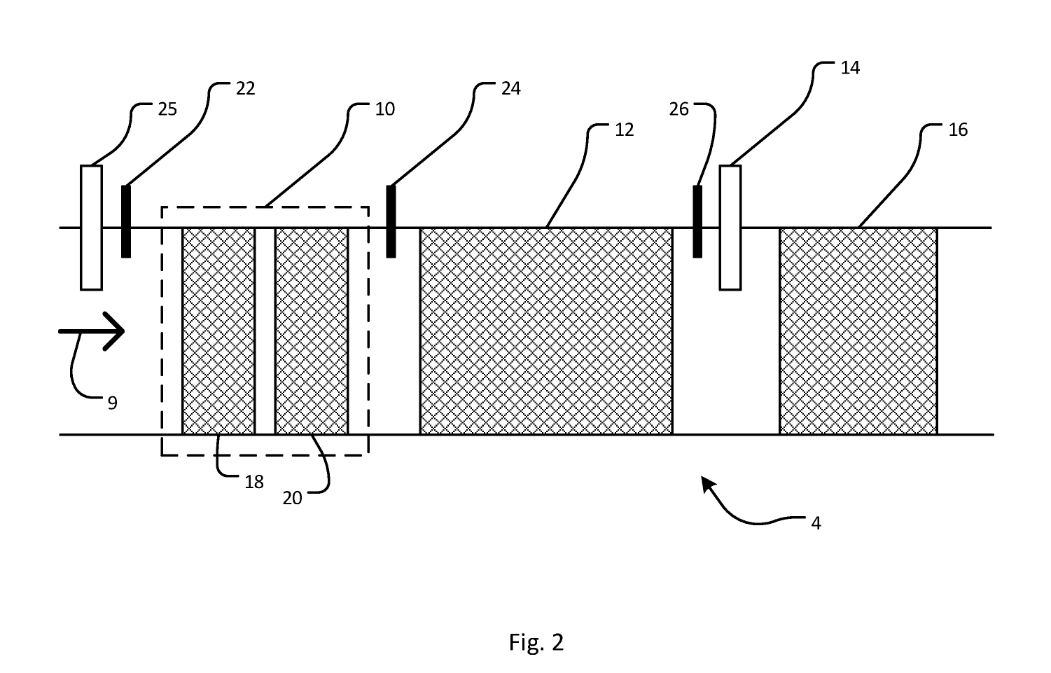

FIG. 2 schematically illustrates one exemplifying embodiment of an exhaust gas treatment system 4 according to the present invention. An arrow 9 indicates the direction of exhaust flow. The terms “downstream” and “upstream” are used with reference to the direction of exhaust flow. The system comprises an oxidation catalyst assembly 10, a particulate filter 12, a reducing agent dosing device 14 and a selective catalytic reduction device 16 arranged downstream of the oxidation catalyst assembly in the flow direction of the exhaust stream through the exhaust gas treatment system. The oxidation catalyst assembly 10 comprises a first oxidation catalyst 18 and a second oxidation catalyst 20 downstream of the first oxidation catalyst 18.

The first oxidation catalyst 18 is capable of catalysing at least partially the oxidation of hydrocarbons present in the exhaust stream in an exothermic reaction. The oxidation reaction should proceed at a sufficient rate at least at temperatures of 300° C. and over. However, it is preferable that the oxidation satisfactorily proceeds at even lower temperatures, such as at 250° C. and over, preferably at 220° C. and over, or even more preferably at 200° C. and over. Importantly however, the first oxidation catalyst is selective and therefore is substantially inert to oxides of sulfur under the prevailing reaction conditions; i.e. at the temperatures and exhaust gas sulfur concentrations prevailing at the first oxidation catalyst. That is to say that the first oxidation catalyst is neither deactivated by sulfur oxides, nor does it catalyse to a substantial extent the reaction of SO₂ to SO₃ under the conditions prevailing at the first oxidation catalyst. A certain degree of reaction or deactivation with sulfur oxides may be tolerable, as long as the catalyst retains sufficient activity to be able to generate heat sufficient to regenerate the PGM catalysts downstream whenever particulate filter regeneration is required. Such selective oxidation catalysts per se are known in the art and are available commercially. For example, catalysts comprising vanadium pentoxide (V₂O₃) or cerium (IV) oxide may be used as the first oxidation catalyst. However, other catalysts possessing the desired properties may be used without departing from the scope of the present invention. Catalysts comprising vanadium pentoxide are preferred, since such catalysts are known to be long-lived and tolerant of the conditions prevalent in the exhaust gas treatment system. The catalyst may suitably have a catalyst loading of 1-2.5 weight % vanadium, preferably 1-1.5 weight % vanadium. Weight % here is calculated with reference to the total dry weight of the washcoat if using a catalytic V₂O₃ washcoated substrate, or with reference to the total weight of the catalyst substrate if the catalytic V₂O₃ is a constituent of the substrate material.

The second oxidation catalyst 20 fully oxidizes any hydrocarbons or partially-oxidized hydrocarbons escaping the first oxidation catalyst, meaning that there is little or essentially no hydrocarbon slip from the oxidation catalyst assembly 10. This function is essential since hydrocarbon slip to the particulate filter leads to reduced formation and/or increased consumption of NO₂ in the particulate filter. As noted previously, only NO₂, and not oxygen, is capable of oxidizing soot at a reasonable rate at the operating temperatures of the exhaust gas system, i.e. <500° C. The second oxidation catalyst is suitably a conventional diesel oxidation catalyst with a substantially sulfur-inert washcoat and/or support. For instance, the catalyst may comprise a platinum group metal (PGM), preferably platinum. Suitable catalyst PGM loadings are 1-50 g/ft³ (35-1770 g/m³).

The first oxidation catalyst 18 and second oxidation catalyst 20 can either share a common catalyst support, or can consist of separate supports for each of the first and second oxidation catalyst 18, 20. When the catalysts 18, 20 share a common support, it is preferred that the catalysts do not overlap to any significant extent, since V₂O₅ may poison the PGM catalyst. The catalyst supports can be of the flow-through monolith sort, although other support types known in the art can be used. The material used can be cordierite, silicon carbide, or any other substrate material known in the art.

The volume ratio of the first oxidation catalyst to the second oxidation catalyst is suitably 4:1 to 1:4, preferably 1.5:1 to 1:1.5, such as about 1:1. Since the first oxidation catalyst performs a large proportion of the hydrocarbon oxidation duties required in the system, the second oxidation catalyst may have lower total quantities of PGM as compared to traditional diesel oxidation catalyst. Thus, the oxidation catalyst assembly may be cheaper to produce than a typical diesel oxidation catalyst. It is also possible to use higher PGM loadings in the second oxidation catalyst, ie. higher quantities of PGM per unit volume, as compared to typical diesel oxidation catalysts. This means that the complete oxidation catalyst assembly 10 need occupy no greater volume than comparable prior art diesel oxidation catalysts, even if the total quantity of PGM is maintained.

The particulate filter 12 can be a typical diesel particulate filter as known in the art. Thus, for example, it can be a wall-flow filter of cordierite or silicon carbide. Preferably, the particulate filter is provided with an oxidation catalyst in order to enhance the production of NO₂ and thus facilitate the regeneration of the filter. The oxidation catalyst coating for the particulate filter may comprise a platinum group metal, preferably platinum, and may have PGM loadings of 0.1-10 g/ft³ (4-350 g/m³).

The reducing agent dosing device 14 is arranged to supply a reducing agent to the exhaust stream upstream of the SCR device 16. The reducing agent, otherwise known as a diesel exhaust fluid, is commonly an aqueous solution of urea in deionized water and is sold under the tradename AdBlue in a number of markets. However, other reducing agents, such as ammonia solutions, are also feasible.

The selective catalytic reduction device 16 comprises an SCR catalyst as known in the art. This catalyst catalyses the reduction of nitrogen oxides (NOₓ) to nitrogen and water, using the reducing agent provided by the reducing agent dosing device 14. Any SCR catalyst known in the art may be used, such as vanadia on titania, copper-zeolite and/or iron-zeolite.

The exhaust gas treatment system 4 may optionally comprise further components, such as sensors, fuel dosing devices, additional particulate filters, ammonia slip catalysts, and so on. For instance, the exhaust gas treatment system 4 may comprise a temperature sensor 22 upstream of the oxidation catalyst assembly 10, a temperature sensor 24 downstream of the oxidation catalyst assembly 10, and a temperature sensor 26 downstream of the particulate filter 12. The exhaust gas treatment system 4 may also comprise a fuel dosing device 25 upstream of the oxidation catalyst assembly 10 in order to facilitate the introduction of hydrocarbons into the exhaust stream whenever necessary. The fuel to be dosed is commonly the same as the fuel provided to the combustion engine, although this is not necessarily the case.

When a vehicle 1, such as the one shown in FIG. 1, equipped with an exhaust gas treatment system 4 is running on high-quality, low-sulfur fuels, such as ultra-low sulfur diesel (USLD), which typically have sulfur content of 15 ppm or less, the exhaust gas treatment system 4 provides comparable results as compared to prior art exhaust treatment systems. The oxidation catalyst assembly 10, together with the optional catalytic coating of the particulate filter 12, forms NO₂ that passively consumes any soot accumulating in the particulate filter 12. The reducing agent dosing device 14 together with the SCR device then account for the removal of NOₓ from the exhaust stream. If the passive regeneration of the particulate filter is insufficient to remove the required quantities of soot, an active regeneration procedure may be performed by dosing fuel to the exhaust stream for a predetermined period, wherein the fuel is fully oxidized by the oxidation catalyst assembly 10, thus raising the temperature of the exhaust stream to a temperature sufficient to effectively regenerate the particulate filter 12, such as about 450° C. Thus, the performance of the exhaust gas treatment system 4 when using low-sulfur fuels is fully comparable with prior art systems, despite requiring lesser amounts of the precious platinum group metals.

Upon the vehicle 1 being run on low-quality, high-sulfur fuels, potentially having a sulfur content of up to 10000 ppm, the functioning of the exhaust gas treatment system is somewhat altered. The sulfur in the fuel is oxidized in the combustion engine to sulfur dioxide which then forms a constituent component of the exhaust stream. This SO₂ in the exhaust stream is to an extent further oxidized by the PGM catalysts of the exhaust gas treatment system, forming SO₃ which is then hydrated to give H₂SO₄. These oxidized sulfur species weakly bind or deposit on the PGM catalysts, washcoats and/or supports. Sulfuric acid (H₂SO₄) can also react with ammonia formed from urea in the exhaust steam, giving ammonium bisulfate (ABS, (NH₄)HSO₄) which deposits on the SCR device 16, reducing the catalytic activity of the SCR device. In this manner, the PGM metal catalysts of the exhaust gas treatment system, i.e. the second oxidation catalyst 20 and particulate filter 12 if catalytically coated, are rapidly, but reversibly, deactivated by the use of high-sulfur fuels. The SCR device 16 may also partially lose activity due to ABS deposits, but since the formation of sulfuric acid is halted once the PGM catalysts are deactivated, most of the catalytic activity of the SCR device 16 is retained. The first oxidation catalyst 18, due to its inherent selectivity and arrangement upstream of the PGM catalysts, is substantially unaffected by the sulfur in the fuel and retains its activity. Due to this selectivity it is however incapable of oxidizing NO to NO₂ in any substantial amounts. Consequently, upon using high-sulfur fuels, the capability of the exhaust gas treatment system 4 to form the NO₂ quantities required to passively regenerate the particulate filter 12 is rapidly diminished, because the first oxidation catalyst is incapable of catalysing the oxidation of NO to NO₂, and the second oxidation catalyst (and particulate filter 12 if catalytic) is deactivated. Thus the passive regeneration capability of the exhaust gas treatment system 4 is diminished, or possibly even lost. The particulate filter 12 still collects soot however, and the SCR device 16 remains substantially active and capable of reducing NOₓ to N₂ and water. The emissions performance of the exhaust gas treatment system 4 therefore remains satisfactory, even when using high-sulfur fuel.

When the particulate filter 12 is full and regeneration is required, the exhaust gas treatment system 4 is capable not only of regenerating the particulate filter 12, but also of reactivating the second oxidation catalyst 20 and the catalytic activity of the particulate filter 12 (if it is a cDFP). What is required to reactivate the catalysts is that the temperature of the exhaust stream is raised to at least in excess of 350° C. in order to desorb and evaporate sulfur species that are deposited on the catalysts. The reactivation and regeneration can be performed even if the vehicle is still running on high-sulfur fuel, although in this case the PGM catalysts will again lose activity shortly after the regeneration procedure is terminated, due to recurrent poisoning with sulfur.

The regeneration and reactivation procedure is performed by introducing fuel into the exhaust stream upstream of the oxidation catalyst assembly 10. Since the first oxidation catalyst 18 has retained hydrocarbon oxidation activity, the fuel in the exhaust stream is oxidized at least partially in an exothermic reaction. The heat released by this reaction quickly raises the temperature of the downstream adjacent second oxidation catalyst 20, freeing it from sulfur deposits. The second oxidation catalyst 20 thus rapidly regains activity and can oxidize NO to NO₂ in order to regenerate the particulate filter. Because the second oxidation catalyst fully oxidizes any hydrocarbons or partially oxidized hydrocarbons having passed the first oxidation catalyst 18, this further raises the temperature of the exhaust stream to a temperature suitable for effective regeneration of the particulate filter, such as about 450° C. At such a temperature, sulfur species deposits on the catalytic coating of the particulate filter 12 and SCR device 16 are also readily removed and these catalysts therefore also regain full activity.

In practice, the regeneration procedure is performed by measuring the temperature downstream of the oxidation catalyst assembly 10 using a temperature sensor 24 and controlling the quantity of fuel introduced to the exhaust stream using feedback control in order to maintain the desired regeneration temperature at the temperature sensor 24. The regeneration temperature is suitably about 450° C. The fuel can be introduced to the exhaust stream by direct injection into the exhaust gas treatment system 4 via a fuel dosing device 25 upstream of the oxidation catalyst assembly 10. Alternatively, the combustion engine can be controlled to provide uncombusted fuel from the engine cylinders.

This regeneration procedure for the exhaust gas treatment system 4 is essentially the same as the procedure typically used for the active regeneration of prior art exhaust gas treatment systems. This, together with the fact that the oxidation catalyst assembly 10 can have the same dimensions as prior art diesel oxidation catalysts, is a great advantage. It means that exhaust gas treatment systems of the invention can be obtained by using the oxidation catalyst assembly 10 as essentially a “drop-in” replacement for the diesel oxidation catalyst in prior art exhaust treatment systems, without the need for extensive reprogramming of control systems or extensive reengineering of the prior art exhaust gas treatment systems.

Another noteworthy feature of the regeneration procedure is that since the first oxidation catalyst only partially oxidizes the hydrocarbons in the exhaust stream, it is not subjected to the entirety of the thermal energy released by the hydrocarbon oxidation. Thus, the temperature attained in the first oxidation catalyst is significantly lower than the temperature attained in the second oxidation catalyst and further downstream. This is advantageous since some catalytic materials suitable for use in the first oxidation catalyst, such as vanadium pentoxide, are prone to sublimation or decomposition at elevated temperatures. Since the first oxidation catalyst is only subjected to temperatures much lower than the target regeneration temperature, the risk of sublimation is minimized.

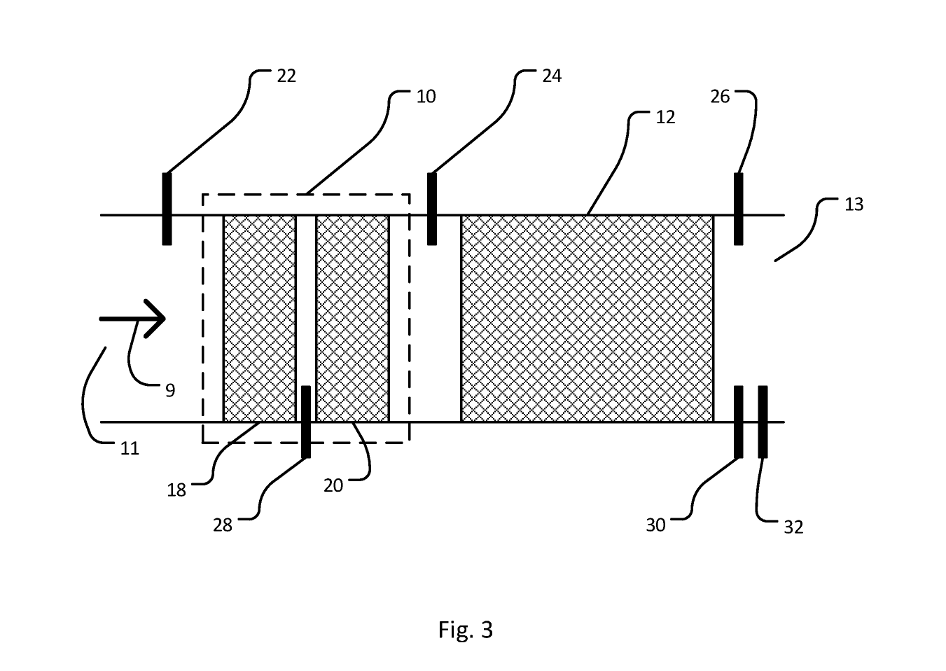

A test configuration to test the regeneration of the exhaust gas treatment system was setup as shown in FIG. 3. The test system had an exhaust stream inlet 11 and outlet 13. The oxidation catalyst assembly 10 comprised of separate supports for the first oxidation catalyst 18 and second oxidation catalyst 20. The first oxidation catalyst comprised V₂O₅ on a cordierite support, the second oxidation catalyst comprised platinum on a cordierite support. The particulate filter 12 comprised a wall-flow filter coated with a catalytic coating of platinum. No SCR device was required in the test setup since it is known to retain activity even when using high-sulfur fuel. Thermocouples 22, 24, 26, 28 were arranged upstream the first oxidation catalyst 18, downstream the second oxidation catalyst 20, downstream the particulate filter 12, and downstream the first oxidation catalyst but upstream the second oxidation catalyst, as shown in FIG. 3. Sensors for measuring hydrocarbon (HC) concentration 30 and NOₓ ratio 32 were arranged downstream of the particulate filter, at the system outlet 13.

Multiple test runs to test the forced regeneration of the exhaust gas treatment system were performed. An inlet temperature of 280° C. and an exhaust flow of 500 kg/h were used. The test was performed using fuel with a sulfur content of 2000 ppm. The target regeneration temperature was 450° C. Each test run was performed by waiting for the temperature to stabilize at thermocouple 26 located at the particulate filter outlet. Fuel dosing was then initiated. The dosing was regulated so that the target temperature of 450° C. was reached at the oxidation assembly outlet (thermocouple 24). The fuel dosing lasted approximately 10 minutes.

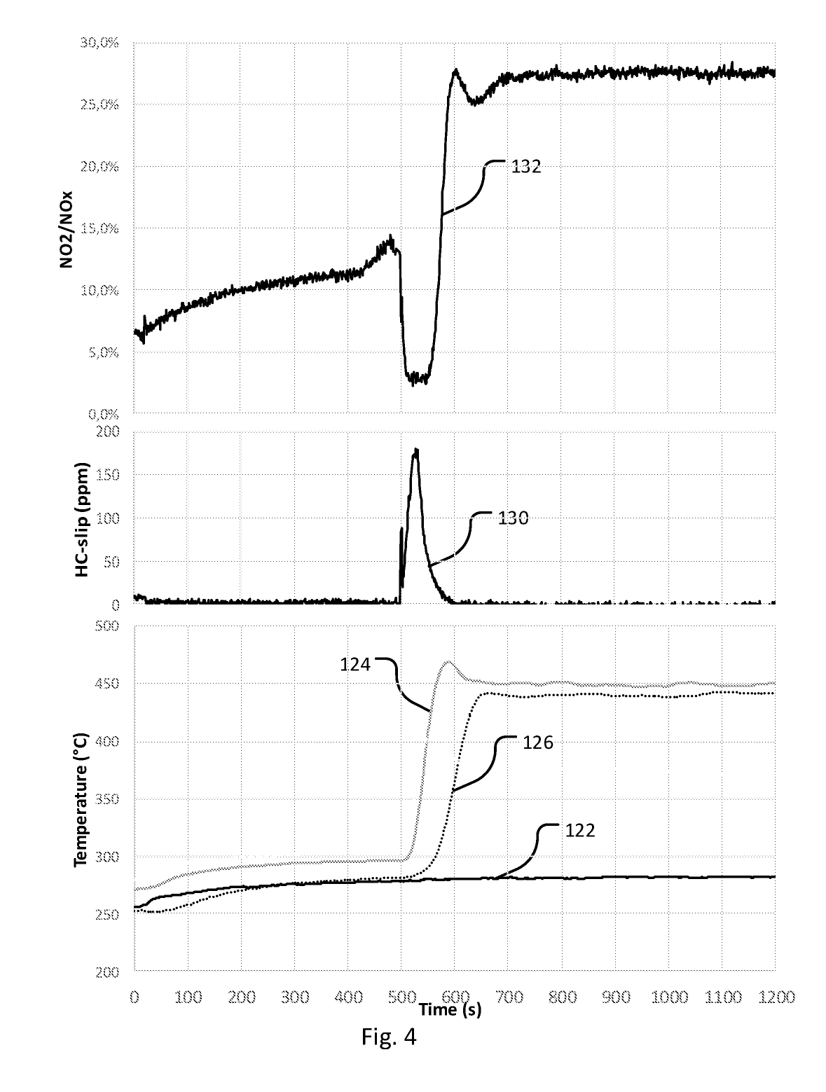

The results of a single test run are shown in FIG. 4. Upon initiation of fuel dosing it can be seen that the exhaust temperature as measured at thermocouples 24 and 26 (i.e. downstream of the oxidation catalyst assembly and particulate filter) is rapidly brought to the regeneration temperature of 450° C. (lines 124 and 126). Little HC slip is observed in the system (line 130). It can also be seen that the NO oxidizing ability of the exhaust gas treatment system is regained and the % NO₂ rises until it reaches the thermodynamic limit (line 132). This indicates that the activity of the system PGM catalysts has been regained. Thus, the use of an oxidation catalyst assembly in an exhaust gas treatment system is capable of providing temperatures and NO₂ concentrations suitable for the oxidation of soot, and thus the regeneration of the particulate filter, even when running on high-sulfur fuel.

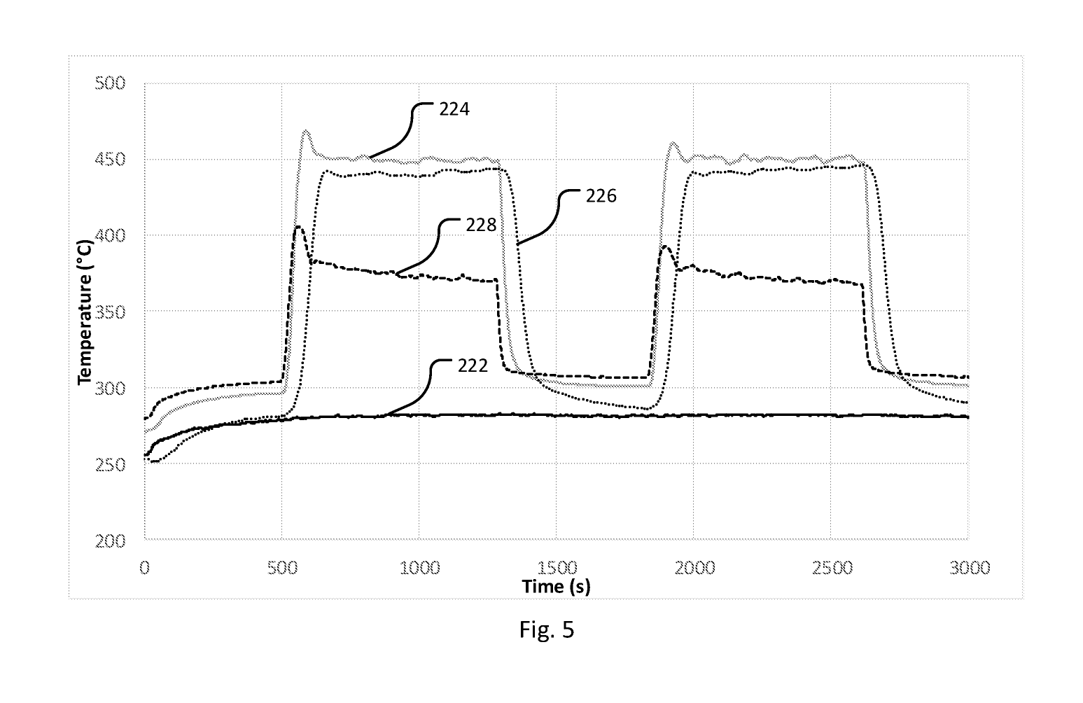

FIG. 5 shows the temperature measured at thermocouples 122, 124, 126 and 128 over a number of test cycles. It can be seen that although the temperatures reached downstream of the oxidation catalyst assembly (line 224) and particulate filter (line 226) are approximately equivalent to the target regeneration temperature of 450° C., the temperature at the outlet of the first oxidation catalyst (line 228) is less than 400° C. Thus, even during the active regeneration procedure, the first oxidation catalyst is not subjected to high temperatures that could possibly, for example, lead to the sublimation of vanadium. Measurement of the vanadium content of the substrate of the second oxidation catalyst confirmed that no significant amounts vanadium had migrated downstream from the first oxidation catalyst.

1. An exhaust gas treatment system, arranged for treatment of an exhaust stream that results from a combustion in a combustion engine, the exhaust treatment system comprising:
an oxidation catalyst assembly comprising:
a first oxidation catalyst arranged to selectively oxidize hydrocarbons present in the exhaust stream, at least partially, with substantially no concomitant oxidation of sulfur oxides present in the exhaust stream; and
a second oxidation catalyst arranged downstream of the first oxidation catalyst, arranged to oxidize hydrocarbons or partially oxidized hydrocarbons having slipped through the first oxidation catalyst, as well as to concomitantly oxidize NO to NO₂;
a particulate filter arranged downstream of the oxidation catalyst assembly;
a reducing agent dosing device arranged downstream of the particulate filter, and arranged to supply a reducing agent into the exhaust stream; and
a selective catalytic reduction device arranged downstream of the reducing agent dosing device, and arranged to reduce nitrogen oxides in the exhaust stream using the reducing agent supplied upstream.

2. An exhaust gas treatment system according to claim 1, wherein the first oxidation catalyst comprises vanadium pentoxide.

3. An exhaust gas treatment system according to claim 2, wherein the vanadium is in the range of 1-2.5 weight.

4. An exhaust gas treatment system according to claim 1, wherein the second oxidation catalyst comprises a platinum group metal.

5. An exhaust gas treatment system according to claim 4, wherein the platinum group metal is 1-50 g/ft³.

6. An exhaust gas treatment system according to claim 1, wherein the particulate filter is catalyzed.

7. An exhaust gas treatment system according to claim 6, wherein the catalyzed particulate filter comprises a platinum group metal.

8. An exhaust gas treatment system according to claim 1, wherein the first and second oxidation catalysts are of the non-plugged flow-through monolith type.

9. An exhaust gas treatment system according to claim 1, wherein the first oxidation catalyst is deposited on a first catalyst support and the second oxidation catalyst is deposited on a second catalyst support.

10. An exhaust gas treatment system according to claim 1, wherein the first oxidation catalyst is deposited on a first portion of a shared catalyst support and the second oxidation catalyst is deposited on a second portion of the shared catalyst support, wherein the first portion of the catalyst support is arranged upstream of the second portion of the catalyst support.

11. An exhaust gas treatment system according to claim 1, wherein the volume ratio of the first oxidation catalyst to the second oxidation catalyst is 4:1 to 1:4.

12. A method of regenerating an exhaust gas treatment system comprising:
an oxidation catalyst assembly comprising:
a first oxidation catalyst arranged to selectively oxidize hydrocarbons present in the exhaust stream, at least partially, with substantially no concomitant oxidation of sulfur oxides present in the exhaust stream; and
a second oxidation catalyst arranged downstream of the first oxidation catalyst, arranged to oxidize hydrocarbons or partially oxidized hydrocarbons having slipped through the first oxidation catalyst, as well as to concomitantly oxidize NO to NO₂;
a particulate filter arranged downstream of the oxidation catalyst assembly;
a reducing agent dosing device arranged downstream of the particulate filter, and arranged to supply a reducing agent into the exhaust stream; and
a selective catalytic reduction device arranged downstream of the reducing agent dosing device, and arranged to reduce nitrogen oxides in the exhaust stream using the reducing agent supplied upstream,
whereby the method comprises:
dosing fuel to an exhaust stream upstream of the oxidation catalyst assembly; and
regulating the fuel dosing using feedback control in order to reach a target regeneration temperature of the exhaust gas stream, as measured by a temperature sensor arranged downstream of the oxidation catalyst assembly and upstream of the particulate filter.

13. A method according to claim 12, whereby dosing the fuel to the exhaust stream is performed by regulating a combustion engine to release uncombusted fuel into the exhaust stream.

14. A method according to claim 12, whereby dosing the fuel to the exhaust stream is performed using a fuel dosing device arranged upstream of the oxidation catalyst assembly.

15. A motor vehicle comprising an exhaust treatment system, arranged for treatment of an exhaust stream that results from a combustion in a combustion engine, the exhaust treatment system comprising:
an oxidation catalyst assembly comprising:
a first oxidation catalyst arranged to selectively oxidize hydrocarbons present in the exhaust stream, at least partially, with substantially no concomitant oxidation of sulfur oxides present in the exhaust stream; and
a second oxidation catalyst arranged downstream of the first oxidation catalyst, arranged to oxidize hydrocarbons or partially oxidized hydrocarbons having slipped through the first oxidation catalyst, as well as to concomitantly oxidize NO to NO₂;
a particulate filter arranged downstream of the oxidation catalyst assembly;
a reducing agent dosing device arranged downstream of the particulate filter, and arranged to supply a reducing agent into the exhaust stream; and
a selective catalytic reduction device arranged downstream of the reducing agent dosing device, and arranged to reduce nitrogen oxides in the exhaust stream using the reducing agent supplied upstream.

16. An exhaust gas treatment system according to claim 2, wherein the vanadium is the range of 1-1.5 weight %.

17. An exhaust gas treatment system according to claim 1, wherein the second oxidation catalyst comprises platinum.

18. An exhaust gas treatment system according to claim 6, wherein the catalyzed particulate filter comprises platinum.

19. An exhaust gas treatment system according to claim 1, wherein the volume ratio of the first oxidation catalyst to the second oxidation catalyst is 1.5:1 to 1:1.5.
